(19) United States
(12) Patent Application Publication
(10) Pub. No.: US 2009/0097787 A1
(43) Pub. Date: Apr. 16, 2009

(54) APPARATUS AND METHOD FOR A BEARING HAVING ANGULATED LOAD SLOT

(75) Inventors: Ronald Richard, Laconia, NH (US); James St. Pierre, Laconia, NH (US); Billy Gene Peaster, Penacook, NH (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: NEW HAMPSHIRE BALL BEARINGS, INC., Chatsworth, CA (US)

(21) Appl. No.: 11/871,049

(22) Filed: Oct. 11, 2007

(51) Int. Cl. F16C 19/00; F16C 33/00; G05G 1/00

(52) U.S. Cl. 384/91; 29/898.04; 74/469

(57) ABSTRACT

A load slot bearing assembly includes an inner bearing member and an outer bearing member. The inner bearing member includes a first circular end, a second circular end, and a spherical outer bearing surface between the first and the second circular ends. The outer bearing member includes a first end surface, a second end surface, and an inner spherical bearing surface between the first and the second end surfaces. The inner spherical bearing surface is shaped to allow the inner bearing member to fit within the outer bearing member. The outer bearing member also has a load slot, which includes a first and a second end faces, and a cylindrical surface extending from one end of the outer bearing member inwardly. The cylindrical surface connects the first and a second end faces. The load slot also includes an angulated surface connecting the cylindrical surface with a portion of the inner spherical bearing surface.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

The present invention is directed generally to bearing assemblies and methods for manufacturing bearing assemblies. More particularly, the invention provides a method and device for a load slot bearing assembly having an angulated or radiused load slot. Merely by way of example, the invention has been applied to a link apparatus for aerospace applications. But it would be recognized that the invention has a much broader range of applicability. For example, the invention can be applied to races, bodies and other external configurations in precision machine applications.

A spherical bearing is a bearing that permits angular rotation in more than one direction. For example, a spherical bearing can support a rotating shaft in the bore of the inner ring that is allowed to move not only rotationally, but also at an angle. A typical spherical bearing includes an inner race member with a spherical outer bearing surface and circular parallel ends mounted for universal movement within an annular outer race member having a spherical inner bearing surface.

A conventional spherical bearing is often made by pressing and deforming an outer race member around a spherical inner race member. This process is often imprecise and non-uniform, producing spherical bearings of inconsistent qualities.

A load slot bearing assembly is a spherical bearing that includes slots provided in the outer race member for allowing sideway insertion of the inner race member in the assembly of the bearing. Thus in a load slot bearing assembly, the inner race member and the outer race member can be manufactured separately. As a result the race members can be made more precisely than conventional spherical bearings.

Even though load slot bearings have been used in certain applications, there are many limitations to conventional load slot bearings. For example, conventional load slot bearings tend to suffer from manufacturing quality problems and reliability issues. Some of these limitations are discussed in more detail below.

Therefore, techniques for improved load slot bearing design is highly desirable.

### BRIEF SUMMARY OF THE INVENTION

The present invention is directed generally to bearing assemblies and methods for manufacturing bearing assemblies. More particularly, the invention provides a method and device for a load slot bearing assembly having an angulated or radiused load slot. Merely by way of example, the invention has been applied to a link apparatus for aerospace applications. But it would be recognized that the invention has a much broader range of applicability. For example, the invention can be applied to races, bodies and other external configurations in precision machine applications.

According to a specific embodiment, the invention provides a load slot bearing assembly, which includes an inner bearing member and an outer bearing member. The inner bearing member includes a first circular end, a second circular end, and a spherical outer bearing surface between the first and the second circular ends. The outer bearing member includes a first end surface and a second end surface. The outer bearing member also includes an inner spherical bearing surface between the first and the second end surfaces. The inner spherical bearing surface is shaped to allow the inner bearing member to fit within the outer bearing member. The outer bearing member also includes a load slot, which includes a first and a second end faces, and a cylindrical surface extending from one end of the outer bearing member inwardly. The cylindrical surface connects the first and a second parallel end faces. The load slot also includes an angulated surface connecting the cylindrical surface with a portion of the inner spherical bearing surface.

In a specific embodiment, the angulated surface is characterized by an angle with the cylindrical surface of the outer bearing member in the range of between about 10° and about 60°. According to embodiments of the invention, the angulated surface is substantially free from cracking and chipping during a high temperature heat treatment. In some embodiments of the invention, the angulated surface is substantially free from cracking and chipping characterized by a size of about 0.05 inches during a high temperature heat treatment. Depending on the embodiment, the outer bearing member of the load slot bearing assembly may include a second angulated load slot, which includes an angulated surface in the load slot. In some embodiments, the cylindrical surface is substantially parallel to an axial direction of the outer bearing member. In other embodiments, the load slot extends from one end of the outer bearing member inwardly to about half a thickness of the outer bearing member.

The angulated surface in the load slot may include various shapes. In some embodiments, the angulated surface is characterized by an angle with the cylindrical surface of the outer bearing member in the range of between about 10° and about 60°. In certain embodiments the angulated surface is characterized by an angle with a tangent of the inner spherical bearing surface of the outer bearing member in the range of between about 10° and about 60°. In a specific embodiment, the angulated surface is characterized by an angle with the cylindrical surface in the range of between about 28° and 32°. In another specific embodiment, the angulated surface is characterized by an angle with a tangent of the inner spherical bearing surface of the outer bearing member in the range of between about 28° and 32°. In an embodiment, the angulated surface is characterized by an angle with the cylindrical surface of about 30°. In alternative embodiments, the angulated surface is characterized by a radius of curvature in a range from about 0.06 inches to about 0.25 inches.

According to another embodiment, the invention provides method for making a load slot bearing assembly. The method includes first forming an intermediate outer bearing member which includes a first circular end surface, a second circular end surface, and an inner spherical bearing surface between the first and the second circular end surfaces. The method also includes forming a load slot in the intermediate outer bearing member using a machining process. The forming of the load slot includes forming a first and a second end faces, and forming a cylindrical surface extending from one end of the outer bearing member inwardly. The cylindrical surface is formed to connect the first and a second end faces. The method also includes forming an angulated surface connecting the cylindrical surface with a portion of the inner spherical bearing surface. A high temperature process, e.g., a nitriding process, is then carried out to harden exposed surface of the intermediate outer bearing member and the load slot.

In a specific embodiment, the intermediate outer bearing member is formed in a high temperature stainless steel material. In an embodiment, the hardening process comprises treating exposed surface of the intermediate outer bearing member and the load slot in a nitrogen ambient at a temperature in the range of about 900°-1200° C. In some embodiments, the method also includes forming a second load slot in the intermediate outer bearing member. The second load slot includes similar features as the first load slot described above, including an angulated surface.

In an alternative embodiment, the invention provides a link apparatus, which includes a shaft and a load slot outer bearing member. In an embodiment, the shaft has a first end and a second end. The load slot outer bearing member is coupled to the first end of the shaft. The load slot outer bearing member includes a first circular end surface, a second circular end surface, and an inner spherical bearing surface connecting the first and the second circular end surfaces. The outer spherical bearing member also includes a load slot. The load slot includes a first and a second parallel end faces, a cylindrical surface, and an angulated surface. The cylindrical surface extends from one end of the outer bearing member inwardly and connects the first and a second parallel end faces. The angulated surface connects the cylindrical surface with a portion of the inner spherical bearing surface.

Many benefits are achieved by way of the present invention over conventional techniques. For example, the present technique provides an easy to use process for making a bearing assembly that relies upon conventional technology. In some embodiments, the invention provides a bearing assembly which includes an angulated load slot which prevents cracking or chipping during a high temperature hardening process. Additionally, the invention provides a process that is compatible with conventional process technology without substantial modifications to conventional equipment and processes. Depending upon the embodiment, one or more of these benefits may be achieved. These and other benefits will be described in more detail throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 is a simplified cross-sectional view diagram of a load slot bearing assembly according to an embodiment of the present invention;

FIG. 2 is a simplified cross-sectional view diagram of the outer bearing member of the load slot bearing assembly of FIG. 1 according to an embodiment of the present invention;

FIG. 3 is simplified an end elevation view diagram of the outer bearing member of the load slot bearing assembly of FIG. 1 according to an embodiment of the present invention;

FIG. 4 is a simplified side view diagram of the inner member of the load slot bearing assembly of FIG. 1 according to an embodiment of the present invention;

FIG. 5 is a simplified enlarged view diagram of a portion of the outer bearing member of the load slot indicated in circle A of FIG. 2 according to an embodiment of the present invention;

FIG. 5A is a simplified view diagram illustrating the relative orientation of the various surfaces in the load slot of FIG. 5 according to an embodiment of the invention;

FIG. 5B is a simplified enlarged view diagram of a portion of the outer bearing member of the load slot according to another embodiment of the present invention;

FIG. 5C is a simplified view diagram illustrating the relative orientation of the various surfaces in the load slot of FIG. 5B;

FIG. 6 is a simplified isometric view diagram of a link apparatus according to an embodiment of the present invention;

FIG. 7 is a simplified top view diagram of the link apparatus of FIG. 6 according to an embodiment of the present invention; and

FIG. 8 is a simplified cross-sectional view diagram across line AA of the link apparatus of FIG. 7 according to an embodiment of the present invention.

### DETAILED DESCRIPTION OF THE INVENTION

The present invention is directed generally to bearing assemblies and methods for manufacturing bearing assemblies. More particularly, the invention provides a method and device for a load slot bearing assembly having an angulated or radiused load slot. Merely by way of example, the invention has been applied to a link apparatus for aerospace applications. But it would be recognized that the invention has a much broader range of applicability. For example, the invention can be applied to races, bodies and other external configurations in precision machine applications.

Depending upon the embodiment, the present invention includes various features, which may be used. These features include the following:

1. A bearing assembly including an angulated load slot;

2. A method for making a bearing assembly using a machining process; and

3. A link apparatus incorporating an angulated load slot.

As shown, the above features may be in one or more of the embodiments to follow. These features are merely examples, which should not unduly limit the scope of the claims herein. One of ordinary skill in the art would recognize many variations, modifications, and alternatives.

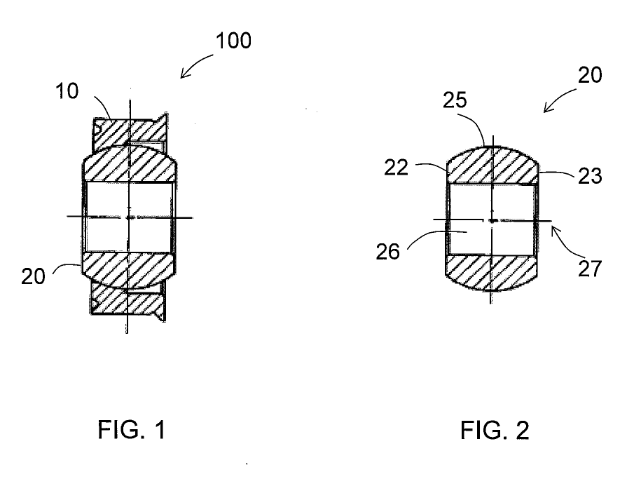

FIGS. 1-4 are simplified view diagrams of a load slot bearing assembly according to an embodiment of the present invention. These diagrams are merely examples, which should not unduly limit the scope of the claims herein. One of ordinary skill in the art would recognize other variations, modifications, and alternatives.

FIG. 1 is a simplified cross-sectional view diagram of a load slot bearing assembly according to an embodiment of the present invention. As shown, bearing assembly 100 includes an outer bearing member 10 (also referred to as the “race”) and an inner bearing member 20 (also referred to as the “ball”). More details of the outer bearing member and the inner bearing member are provided below with reference to FIGS. 2-4.

FIG. 2 is a simplified cross-sectional view diagram of the inner member of the load slot bearing assembly of FIG. 1 according to an embodiment of the present invention. As shown, inner bearing member 20 includes a first circular end 22, a second circular end 23, and a spherical outer bearing surface 25 between the first and the second circular ends. The inner bearing member 20 also includes a cylindrical bore 26 with an axis 27. In an embodiment, the axis 27 is perpendicular to the circular ends 22 and 23.

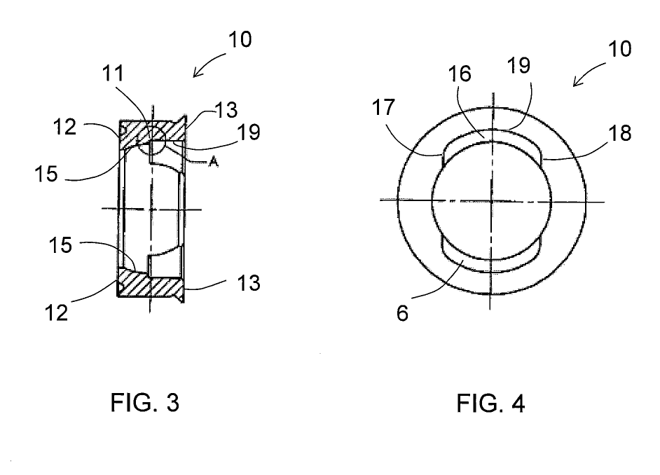

FIG. 3 is simplified an end elevation view diagram of the outer bearing member of the load slot bearing assembly of FIG. 1 according to an embodiment of the present invention. As shown, outer bearing member 10 includes a first circular end surface 12 and a second circular end surface 13. The outer bearing member 10 also includes an inner spherical bearing surface 15 between the first and the second circular end surfaces. The inner spherical bearing surface 15 allows the inner bearing member 20 to fit within the outer bearing member 10.

FIG. 4 is a simplified side view diagram of the outer bearing member of the load slot bearing assembly of FIG. 1 according to an embodiment of the present invention. As shown, the outer bearing member 10 also includes a load slot 16. The load slot 16 includes two end faces; a first end face 17 and a second end face 18. The load slot 16 also includes a cylindrical surface 19 connecting the first and a second end faces 17 and 18. In an embodiment, the distance between the end faces 17 and 18 of the loader slots 19 is slightly greater than the width of the inner bearing member 20. As a result, the load slot allows the inner bearing member 20 to be inserted sideways into the outer bearing member 10 and then rotated 90° into its assembled position as shown in FIG. 1. In a specific embodiment, the end faces are parallel. Of course, there can be other variations and modifications.

Referring back to FIG. 3, the cylindrical surface 19 extends from one end of the outer bearing member 13 inwardly toward a center plane of the outer bearing member 10. In an embodiment, the outer bearing member includes an angulated surface 11 connecting the cylindrical surface 19 with a portion of the inner spherical bearing surface 15. Further details of the angulated surface 11 as shown in circle A in FIG. 3 are provided below.

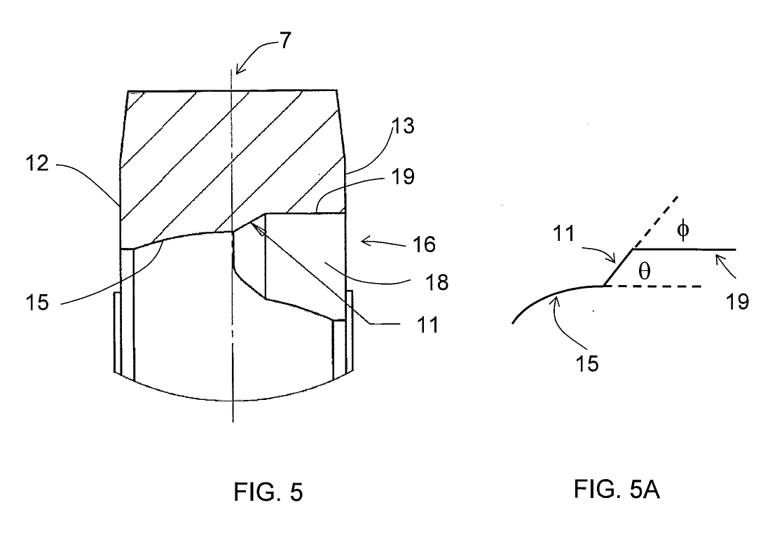

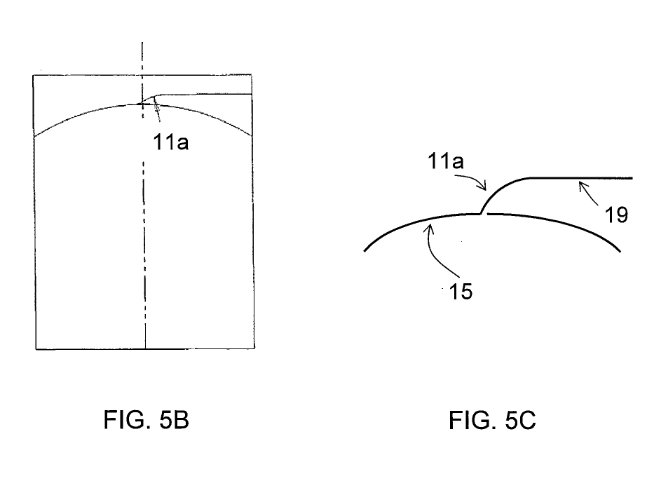

FIG. 5 is an simplified enlarged view diagram of a portion of the outer bearing member of the load slot bearing assembly including the portion marked as circle A in FIG. 3 according to an embodiment of the present invention. This diagram is merely an example, which should not unduly limit the scope of the claims herein. One of ordinary skill in the art would recognize other variations, modifications, and alternatives. As shown, the outer bearing member includes a spherical bearing surface 15 which allows the inner bearing member 20 to fit into the outer bearing member 10. The cylindrical surface 19 provides a wider opening through which the inner bearing member can be inserted sideways during the assembly process. In a specific embodiment of the present invention, the angulated surface 11 connects the cylindrical surface 19 with a portion of the inner spherical bearing surface 15, as shown in FIG. 5.

Depending on the embodiment, the outer bearing member of the load slot bearing assembly may include a second angulated load slot, which includes an angulated surface in the load slot. An example of the second load slot is shown in FIG. 4 as load slot 6, which has similar features as load slot 16 described above. In some embodiments, the cylindrical surface is substantially parallel to an axial direction of the outer bearing member. In other embodiments, the load slot extends from one end of the outer bearing member inwardly to about half the thickness of the outer bearing member. As shown in FIG. 5, the load slot including the cylindrical surface 19 and the angulated surface 11 extends from end surface 13 to approximately a center line 7 of the outer bearing member.

The angulated surface in the load slot may have various shapes. FIG. 5A is a simplified view diagram illustrating the relative orientation of the various surfaces in the load slot according to a specific embodiment of the invention. This diagram is merely an example, which should not unduly limit the scope of the claims herein. One of ordinary skill in the art would recognize other variations, modifications, and alternatives. In some embodiments, the angulated surface 11 forms an angle Φ with the cylindrical surface 19 of the outer bearing member in the range of between about 10° and about 60°. In certain embodiments, the angulated surface 11 forms an angle θ with a tangent of the inner spherical bearing surface 15 of the outer bearing member in the range of between about 10° and about 60°. In a specific embodiment, the angulated surface forms an angle Φ with the cylindrical surface in the range of between about 28° and 32°. In another specific embodiment, the angulated surface forms an angle θ with a tangent of the inner spherical bearing surface of the outer bearing member in the range of between about 28° and 32°. In some embodiments, the angles Φ and θ are approximately 30°. Of course, there can be other variations, modifications, and alternatives.

In some embodiments, the cylindrical surface 19 and the angulated surface 11 may include curved portions, even though they are shown as straight line segments in drawings such as FIGS. 5 and 5A. In other embodiments, the interface between the cylindrical surface 19 and the angulated surface 11 may include a rounded corner. Similarly the interface between the angulated surface 11 and the spherical inner bearing surface 15 may include a rounded corner. More details are provided in the example discussed below.

FIG. 5B is a simplified enlarged view diagram of a portion of the outer bearing member of the load slot according to another embodiment of the present invention. FIG. 5C is a simplified view diagram illustrating the relative orientation of the various surfaces in the load slot of FIG. 5B. These diagrams are merely examples, which should not unduly limit the scope of the claims herein. One of ordinary skill in the art would recognize other variations, modifications, and alternatives. In FIG. 5B, the angulated surface includes a curved surface 11a. As shown in FIG. 5C, the angulated surface 11a connects the cylindrical surface 19 with a portion of the inner spherical bearing surface 15. Accordingly, a tapered transition region is provided in the load slot of the bearing. As shown in the embodiments in FIGS. 5A and 5C, sharp corners and high-stress regions are avoided.

Depending on the applications, the load slot bearing assembly discussed above can be made in different sizes. In some embodiments, the thickness of the bearing assembly is about 0.2 inches, and the inner diameter of the outer bearing member is about 0.5 inches. In certain embodiments, the curved surface 11a has a radius of curvature of about 0.06 to 0.25 inches. In a specific embodiment, the curved surface 11a can include a segment that has a radius of curvature of about 0.015 inches. Of course, there can be other variations, modifications, and alternatives.

Although the above has been shown using a selected group of components for the load slot bearing assembly, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification and more particularly below.

According to an embodiment of the invention, a method is provided for making a load slot bearing assembly. In a specific embodiment, the outer bearing member of a load slot bearing assembly may be made using a machining process. In an embodiment, an intermediate outer bearing member is made of stainless steel using a machining or casting method. The outer bearing member includes a first circular end surface, a second circular end surface, and an inner spherical bearing surface between the first and the second circular end surfaces. The stainless steel material may be 15-5-PH stainless steel or a high temperature stainless steel, such as Greek Ascoloy®. Depending on the embodiment, other types of stainless steel material may also be used. In a specific embodiment, a machining process is used to form the load slot in the intermediate outer bearing member. The load slot includes the features describe above with reference to FIGS. 1-5A. As discussed above, the load slot includes a first and a second end faces, a cylindrical surface extending from one end of the outer bearing member inwardly and connecting the first and a second end faces. The load slot also includes an angulated surface connecting the cylindrical surface with a portion of the inner spherical bearing surface. Of course, there can be other variations, modifications, and alternatives.

In some embodiments, a high-temperature treatment process is performed for hardening the surface of the bearing members. In a specific embodiment, a nitriding process is used, which includes treating the exposed surface of the bearing members in a nitrogen atmosphere at a temperature in the range of approximately 900° C.-1200° C. During the heat treatment, stress may develop at sharp corners in the bearing structure, causing cracking and chipping. In some instances, the cracking and chipping may have a size of about 0.05 inches. In embodiments of the present invention, an angulated surface is provided between the cylindrical surface at the opening of the load slot and the spherical bearing surface inside the outer bearing. A tapered region is provided in the load slot to avoid stress buildup at sharp corners and the resultant cracking and chipping. According to embodiments of the invention, the angulated surface is substantially free from cracking and chipping during a high temperature heat treatment. In some embodiments of the invention, the angulated surface is substantially free from cracking and chipping characterized by a size of about 0.05 inches during a high temperature heat treatment.

As discussed above, in some embodiments, the angulated surface forms a first angle with a cylindrical surface of the load slot of the outer bearing member and forms a second angle with a tangent of the inner spherical bearing surface of the outer bearing member. Depending on the embodiments, the first angle and the second angle may be in the range of between about 10° and about 60°. In a specific embodiment, the first angle and the second angle are in a range between about 28° and 32°. Alternatively, a curve surface can also be included in the angulated surface. Of course, one skilled in the art may recognize other variations, modifications, and alternatives.

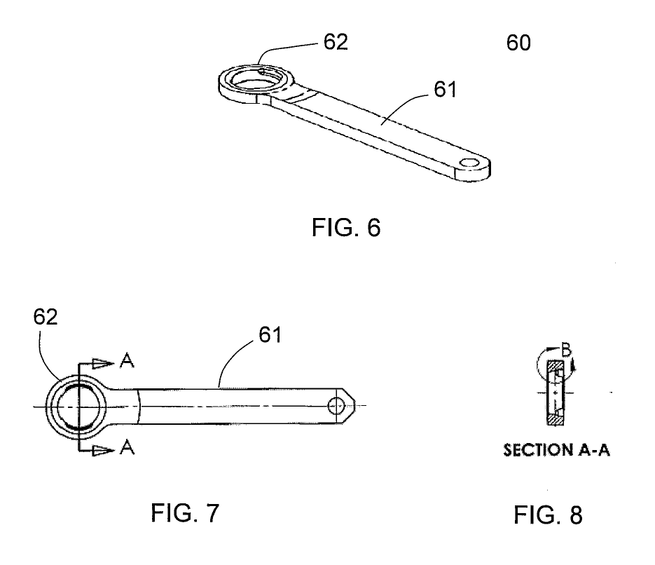

FIGS. 6-8 are simplified view diagrams of a link apparatus according to an embodiment of the present invention. These diagrams are merely examples, which should not unduly limit the scope of the claims herein. One of ordinary skill in the art would recognize other variations, modifications, and alternatives. Specifically, FIG. 6 is a simplified isometric view diagram of a link apparatus 60 according to an embodiment of the present invention, and FIG. 7 is a simplified top view diagram of the link apparatus 60. As shown, the link apparatus 60 includes a shaft 61 and a load slot outer bearing member 62. The shaft 61 has a first end and a second end. The load slot outer bearing member 62 is coupled to the first end of the shaft. FIG. 8 is a simplified cross-sectional view diagram across line AA of the link apparatus of FIG. 7 according to an embodiment of the present invention. As shown, the load slot outer bearing member 62 includes a load slot as discussed above in connection to FIGS. 1-5A. Among other elements, the load slot outer bearing member 62 includes an angulated surface in the load slot as shown in circle B in FIG. 8. In an embodiment, the outer bearing member 62 may include a second load slot having an angulated surface.

Although the above has been shown using a selected group of components for the link apparatus including an angulated load slot, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

A link apparatus finds many applications. In certain embodiments, a link apparatus such as the one described above can be used in aerospace or vehicular applications. For example, the link apparatus can be used in a helicopter rotor, landing gear, actuator, and other support bearing applications, according to embodiments of the present invention.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A load slot bearing assembly, the bearing assembly comprising:
an inner bearing member including a first circular end, a second circular end, and a spherical outer bearing surface between the first and the second circular ends; and
an outer bearing member, the outer bearing member including:
a first end surface and a second end surface;
an inner spherical bearing surface between the first and the second end surfaces, the inner spherical bearing surface allowing the inner bearing member to fit within the outer bearing member;
a load slot, the load slot including a first and a second end faces;
a cylindrical surface extending from the first end surface of the outer bearing member inwardly and connecting the first and the second end faces of the load slot; and
an angulated surface connecting the cylindrical surface with a portion of the inner spherical bearing surface for forming a continuous region with the cylindrical surface and the portion of the inner spherical bearing surface,
the angulated surface being characterized by an angle with respect to the cylindrical surface in the range of between about 10° and about 60°,
the angulated surface being configured to be substantially free of cracking and chipping characterized by a size of about 0.05 inches during a high temperature heat treatment.

2. The load slot bearing assembly of claim 1 wherein the cylindrical surface is substantially parallel to an axial direction of the outer bearing member.

3. The load slot bearing assembly of claim 1 wherein the angulated surface forms an angle with a tangent of the inner spherical bearing surface of the outer bearing member in the range of between about 10° and about 60°.

4. The load slot bearing assembly of claim 1 wherein the angulated surface is characterized by an angle with the cylindrical surface in the range of between about 28° and 32°.

5. The load slot bearing assembly of claim 1 wherein the angulated surface is characterized by an angle with a tangent of the inner spherical bearing surface of the outer bearing member in the range of between about 28° and 32°.

6. The load slot bearing assembly of claim 1 wherein the angulated surface is characterized by an angle with the cylindrical surface of about 30°.

7. The load slot bearing assembly of claim 1 wherein the angulated surface is characterized by a radius of curvature in a range from about 0.06 inches to about 0.25 inches.

8. The load slot bearing assembly of claim 1 wherein the load slot extends from the first end surface of the outer bearing member inwardly to approximately a mid point of the spherical inner bearing surface.

9. The load slot bearing assembly of claim 1 wherein allowing the inner bearing member to be rotatably inserted into the outer bearing member.

10. The load slot bearing assembly of claim 1 further comprising a second load slot, the second load slot including an angulated surface.

11. A load slot bearing assembly, the bearing assembly comprising:
an inner bearing member including a first circular end a second circular end, and a spherical outer bearing surface connecting the first and the second circular ends; and
an outer bearing member, the outer bearing member including:
a first circular end surface and a second circular end surface;
an inner spherical bearing surface connecting the first and the second circular end surfaces, the inner spherical bearing surface allowing the inner bearing member to fit within the outer bearing member;
a load slot, the load slot including a first and a second parallel end faces; and
a cylindrical surface extending from the first circular end surface of outer bearing member inwardly and connecting the first and a second parallel end faces, and
an angulated surface connecting the cylindrical surface with a portion of the inner spherical bearing surface for forming a continuous region with the cylindrical surface and the portion of the inner spherical bearing surface.

12. The load slot bearing assembly of claim 11 wherein the angulated surface is characterized by an angle with the cylindrical surface in the range of between about 28° and 32°.

13. The load slot bearing assembly of claim 11 wherein the angulated surface is characterized by an angle with the inner spherical surface in the range of between about 28° and 32°.

14. The load slot bearing assembly of claim 11 wherein the angulated surface is characterized by a radius of curvature in a range from about 0.06 inches to about 0.25 inches.

15. The load slot bearing assembly of claim 11 further comprising a second load slot, the second load slot including an angulated surface.

16. A method for making a load slot bearing assembly, the method comprising:
forming an intermediate outer bearing member, the intermediate outer bearing member including a first circular end surface, a second circular end surface, and an inner spherical bearing surface between the first and the second circular end surfaces;
forming a load slot in the intermediate outer bearing member using a machining process, including:
forming a first and a second end faces of the load slot;
forming a cylindrical surface extending from the first circular end of the outer bearing member inwardly and connecting the first and a second end faces; and
forming an angulated surface connecting the cylindrical surface with a portion of the inner spherical bearing surface; and
hardening exposed surface of the intermediate outer bearing member and the load slot using a high temperature process.

17. The method of claim 16 wherein the intermediate outer bearing member is formed in a high temperature stainless steel material.

18. The method of claim 16 wherein the angulated surface forms an angle with the cylindrical surface of the outer bearing member in the range of between about 10° and about 60°.

19. The method of claim 16 wherein the angulated surface is characterized by a radius of curvature in a range from about 0.06 inches to about 0.25 inches.

20. The method of claim 16 wherein the hardening process comprises treating exposed surface of the intermediate outer bearing member and the load slot in a nitrogen ambient at a temperature in the range of about 900°-1200° C.

21. The method of claim 16 further comprising forming a second load slot in the intermediate outer bearing member, the second load slot including an angulated surface.

22. A link apparatus, comprising:
a shaft having a first end and a second end; and
a load slot outer bearing member coupled to the first end of the shaft, the load slot outer bearing member including:
a first circular end surface and a second circular end surface;
an inner spherical bearing surface connecting the first and the second circular end surfaces, the inner spherical bearing surface allowing the inner bearing member to fit within the outer bearing member; and
a load slot, the load slot including:
a first and a second end faces;
a cylindrical surface extending from one end of the outer bearing member inwardly and connecting the first and a second parallel end faces; and
an angulated surface connecting the cylindrical surface with a portion of the inner spherical bearing surface.

23. The apparatus of claim 22 wherein the angulated surface forms an angle with the cylindrical surface of the outer bearing member in the range of between about 10° and about 60°.

24. The apparatus of claim 22 wherein the angulated surface is characterized by a radius of curvature in a range from about 0.06 inches to about 0.25 inches.

25. The apparatus of claim 22 further comprising a second load slot, the second load slot including an angulated surface.

26. The apparatus of claim 22, wherein the link apparatus is used in an aerospace application.
